(19) United States
(12) Patent Application Publication
(10) Pub. No.: US 2008/0174539 A1
(43) Pub. Date: Jul. 24, 2008

(54) DISPLAY DEVICE AND RELATED DRIVING METHOD CAPABLE OF REDUCING SKEW AND VARIATIONS IN SIGNAL PATH DELAY

(76) Inventors: Yu-Tsung Hu, Changhua County (TW); Hsing-Hui Chao, Tainan County (TW)

Correspondence Address: NORTH AMERICA INTELLECTUAL PROPERTY CORPORATION, P.O. BOX 506, MERRIFIELD, VA, 22116, US

(21) Appl. No.: 11/689,518

(22) Filed: Mar. 22, 2007

(30) Foreign Application Priority Data
Jan. 24, 2007 (TW) 096102674

(51) Int. Cl. G09G 3/36

(52) U.S. Cl. 345/99

(57) ABSTRACT

An LCD device includes an LCD panel, a timing controller, a plurality of gate drivers, and a plurality of source drivers. The timing controller generates a plurality of horizontal synchronization signals respectively corresponding to the plurality of source drivers based on the signal transmission paths between the plurality of source drivers and the timing controller. The timing controller generates a plurality of vertical synchronization signals respectively corresponding to the plurality of gate drivers based on the signal transmission paths between the plurality of gate drivers and the timing controller. Each source driver outputs a source driving signal based on a horizontal clock signal, a data signal, a horizontal control signal, and a corresponding horizontal synchronization signal. Each gate driver outputs a gate driving signal based on a vertical clock signal, a vertical control signal, and a corresponding vertical synchronization signal.

### BACKGROUND OF THE INVENTION

1. Field of the Invention

The present invention relates to a display device and related driving method, and more particularly, to a display device and related driving method capable of reducing skew and variations in signal path delay.

2. Description of the Prior Art

With rapid development in display technologies, flat panel displays (FPD) have gradually replaced traditional cathode ray tube (CRT) displays and been widely applied in electronic devices, such as notebook computers, personal digital assistants (PDAs), flat panel televisions or mobile phones. Common FPDs include thin film transistor liquid crystal display (TFT LCD) devices, low temperature poly silicon liquid crystal display (LTPS LCD) devices and organic light emitting diode (OLED) display devices. The driving system of an LCD device includes a timing controller, a source driver, a gate driver, and signal lines for transmitting various signals (such as clock signal lines, data signal lines and control signal lines).

Reference is made to FIG. 1 for a diagram illustrating a prior art L-configuration LCD device 10. The LCD device 10 includes an LCD panel 12, a timing controller 14, a plurality of gate drivers GD₁-GDₘ, and a plurality of source drivers CD₁-CDₙ. The timing controller 14 can generate a data signal DATA corresponding to images to be displayed on the LCD panel 12, a horizontal synchronization signal STH₁ for accessing valid data, a horizontal clock signal CLK and horizontal control signals for operating the source drivers CD₁-CDₙ, as well as a vertical synchronization signal STV₁, a vertical clock signal CPV and vertical control signals for operating the gate drivers GD₁-GDₘ. In FIG. 1, the horizontal control signals include a latch control signal LD and a polarity control signal POL, while the vertical control signals include an output enable signal OE. In the prior art LCD device 10, the timing controller 14 respectively outputs the horizontal synchronization signal STH₁ and the vertical synchronization signal STV₁ to the source driver CD₁ and the gate driver GD₁, while the synchronization signals for operating the source drivers CD₂-CDₙ and the gate drivers GD₂-GDₘ are respectively generated by corresponding source drivers and gate drivers of the prior level. In other words, the source drivers CD₁-CDₙ₋₁ respectively output the horizontal synchronization signal STH₂-STHₙ to the source drivers CD₂-CDₙ, while the gate drivers GD₁-GDₘ₋₁ respectively output the vertical synchronization signals STV₂-STVₘ to the gate driver GD₂-GDₘ. Therefore, the timing controller 14 can output source driving signals to the sources drivers CD₁-CDₙ based on the data signal DATA, the corresponding horizontal synchronization signals, the horizontal clock signal CLK, the latch control signal LD, and the polarity control signal POL. Meanwhile, the timing controller 14 can also output gate driving signals to the gate drivers GD₁-GDₘ based on the corresponding vertical synchronization signals, the vertical clock signal CPV, and the output enable signal OE.

The number of the sources drivers CD₁-CDₙ and the gate drivers GD₁-GDₘ increases as panel sizes become larger. In the prior art LCD device 10, the layouts of the signal lines can vary since the distances between the timing controller 14 and the source drivers CD₁-CDₙ may be different. Unlike the source driver CD₁ which receives the horizontal synchronization signal STH₁ directly from the timing controller 14, other source drivers CD₂-CDₙ receive corresponding horizontal synchronization signals respectively from the source drivers CD₁-CDₙ₋₁ of the prior level instead. Similarly, the layouts of the signal lines can vary since the distances between the timing controller 14 and the gate drivers GD₁-GDₘ may be different. Unlike the gate driver GD₁ which receives the vertical synchronization signal STV₁ directly from the timing controller 14, other gate drivers GD₂-GDₘ receive corresponding vertical synchronization signals respectively from the gate drivers GD₁-GDₘ₋₁ of the prior level instead. Therefore, each horizontal/vertical synchronization signal encounters different signal path delay as a result of different circuit layouts. The variations between the signal path delays among different synchronization signals increase with the number of the drivers. It becomes thus more and more difficult to synchronize the data signal, the clock signal, the control signals and the horizontal/vertical synchronization signals, or to adjust the timing parameters. Different amounts of signal path delay largely influence display quality of LCD devices, especially in high-speed and high-resolution applications.

Reference is made to FIG. 2 for a diagram illustrating a prior art T-configuration LCD device 20. The LCD device 20 includes an LCD panel 22, a timing controller 24, a plurality of gate drivers GD₁-GDₘ, and a plurality of source drivers CD_{1F}-CD_{nF} and CD_{1B}-CD_{nB}. The source drivers of the LCD device 20 include n front-port source drivers CD_{1F}-CD_{nF} and n back-port source drivers CD_{1B}-CD_{nB}, wherein the timing controller 24 is disposed between the front-port source drivers CD_{1F}-CD_{nF} and the back-port source drivers CD_{1B}-CD_{nB}. The timing controller 24 can generate data signals DATA_{F} and DATA_{B} corresponding to images to be displayed on the LCD panel 22, horizontal synchronization signals STH_{1F}and STH_{1B} for accessing valid data, horizontal clock signals CLK_{F}, CLK_{B} and horizontal control signals for operating the source drivers CD₁-CDₙ, as well as a vertical synchronization signal STV₁, a vertical clock signal CPV and vertical control signals for operating the gate drivers GD₁-GDₘ. In FIG. 2, the horizontal control signals include a latch control signal LD and a polarity control signal POL, while the vertical control signals include an output enable signal OE. In the prior art LCD device 20, the timing controller 24 outputs the horizontal synchronization signals STH_{1F} and STH_{1B} respectively to the front-port source driver CD_{1F} and the back-port source driver CD_{1B} simultaneously, while the synchronization signals for operating the front-port source drivers CD_{2F}-CD_{nF} and the back-port source drivers CD_{2B}-CD_{nB}. are respectively generated by corresponding front-port and back-port source drivers of the prior level. Similarly, the timing controller 24 outputs the vertical synchronization signals STV₁ to the gate driver GD₁, while the vertical synchronization signals for operating the gate drivers GD₂-GDₘ are respectively generated by corresponding gate drivers of the prior level. In other words, the front-port source drivers CD_{1F}-CD_{(n-1)F} respectively output the horizontal synchronization signal STH_{2F}-STH_{nF} to the front-port source drivers CD_{2F}-CD_{nF}, the back-port source drivers CD_{1B}-CD_{(n-1)B} respectively output the horizontal synchronization signal STH_{2B}-STH_{nB} to the back-port source drivers CD_{2B}-CD_{nB}, and the gate drivers GD₁-GDₘ₋₁ respectively output the vertical synchronization signals STV₂-STVₘ to the gate driver GD₂-GDₘ. Therefore, the timing controller 24 can output source driving signals to the front-port sources drivers CD_{1F}-CD_{nF} based on the data signal DATA_{F}, the corresponding horizontal synchronization signals, the horizontal clock signal CLK_{F}, the latch control signal LD, and the polarity control signal POL, can output source driving signals to the back-port sources drivers CD_{1B}-CD_{nB} based on the data signal DATA_{B}, the corresponding horizontal synchronization signals, the horizontal clock signal CLK_{B}, the latch control signal LD, and the polarity control signal POL, and can output gate driving signals to the gate drivers GD₁-GDₘ based on the corresponding vertical synchronization signals, the vertical clock signal CPV, and the output enable signal OE.

Reference is made to FIG. 3 for a timing diagram illustrating the operations of the source drivers in the prior art LCD device 20. In FIG. 3, STH represents the ideal waveform of the synchronization signals received by the front/back-port source drivers. STH_{F} represents the actual waveform of the synchronization signals received by the front-port source drivers. STH_{B} represents the actual waveform of the synchronization signals received by the back-port source drivers. Waveform DATA represents the ranges of valid and invalid data. DATA_LINE represents the accessed data lines. Ideally, the horizontal synchronization signals STH_{1F}/STH_{1B}, STH_{2F}/STH_{2B}, . . . , STH_{nF}/STH_{nB} are synchronized with respect to each other, as illustrated by waveform STH. However in the actual case, the horizontal synchronization signals may encounter different degrees of signal path delays, as illustrated by waveforms STH_{F} and STH_{B}.

In large-size applications, the prior art LCD device 20 can reduce the variations of signal path delay among the synchronization signals received by different drivers. However, only the front-port source driver CD_{1F}, the back-port source driver CD_{1B} and the gate driver GD₁ receive synchronization signals directly from the timing controller 23. Since other drivers receive synchronization signals from corresponding drivers of the prior level, different synchronization signals may still encounter different amounts of signal path delay, which largely influence the display quality of the LCD device 20.

### SUMMARY OF THE INVENTION

The present invention provides an LCD device capable of reducing skew and variations in signal path delay comprising an LCD panel including a plurality of display units; a plurality of source drivers each capable of outputting a source driving signal to corresponding display units of the LCD display panel based on a horizontal clock signal, a data signal, a horizontal control signal, and a corresponding horizontal synchronization signal; and a timing controller for generating the horizontal clock signal, the data signal and the horizontal control signal, and for outputting a plurality of horizontal synchronization signals respectively corresponding to the plurality of source drivers based on signal transmission paths between the plurality of source drivers and the timing controller.

The present invention also provides method capable of reducing skew and variations in signal path delay in a display device comprising a timing controller outputting a plurality of horizontal synchronization signals respectively corresponding to a plurality of source drivers based on signal transmission paths between the plurality of source drivers and the timing controller; and a source driver among the plurality of source drivers outputting a source driving signal based on a horizontal clock signal, a data signal, a horizontal control signal, and a corresponding horizontal synchronization signal among the plurality of horizontal synchronization signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art L-configuration LCD device.

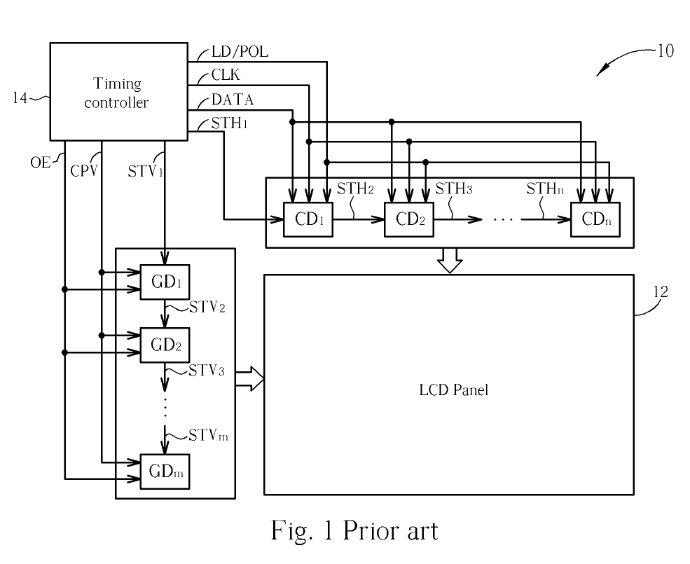

FIG. 2 is a diagram illustrating a prior art T-configuration LCD device.

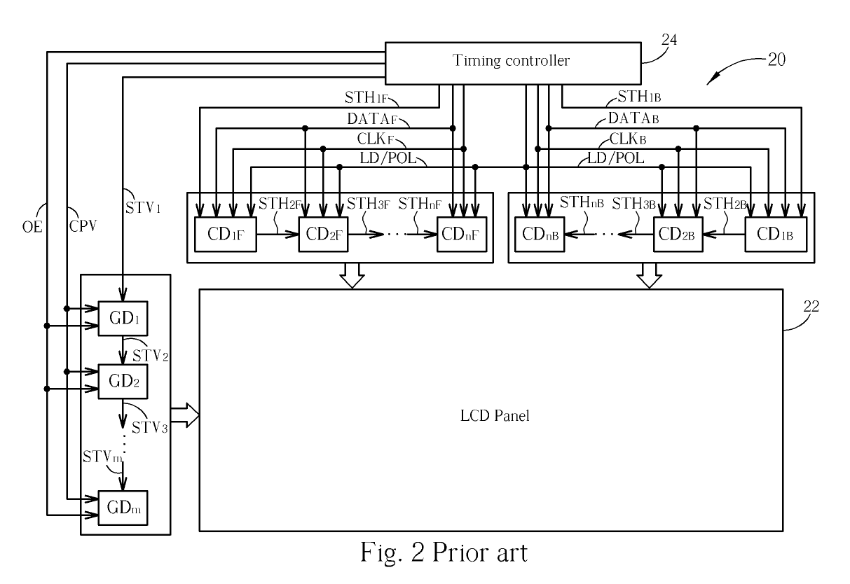

FIG. 3 is a timing diagram illustrating the operations of the source drivers in the prior art LCD device in FIG. 2.

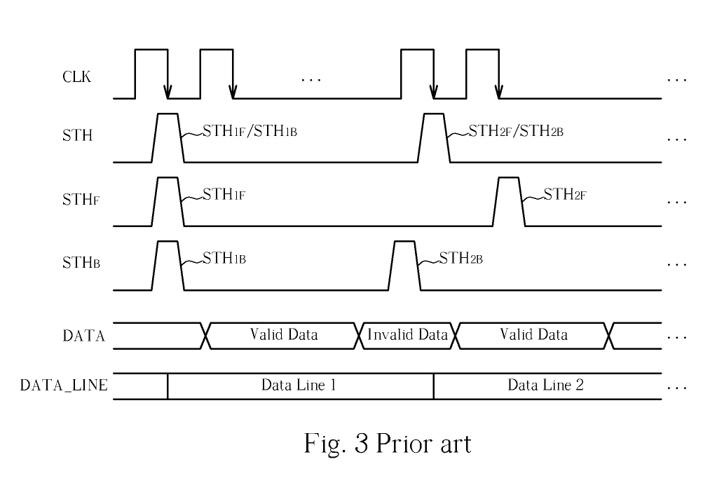

FIG. 4 is a diagram illustrating an L-configuration LCD device according to a first embodiment of the present invention.

FIG. 5 is a timing diagram illustrating the operations of the source drivers in the LCD device according to the present invention.

FIG. 6 is a diagram illustrating a T-configuration LCD device according to a second embodiment of the present invention.

FIG. 7 is a diagram illustrating a T-configuration LCD device according to a third embodiment of the present invention.

### DETAILED DESCRIPTION

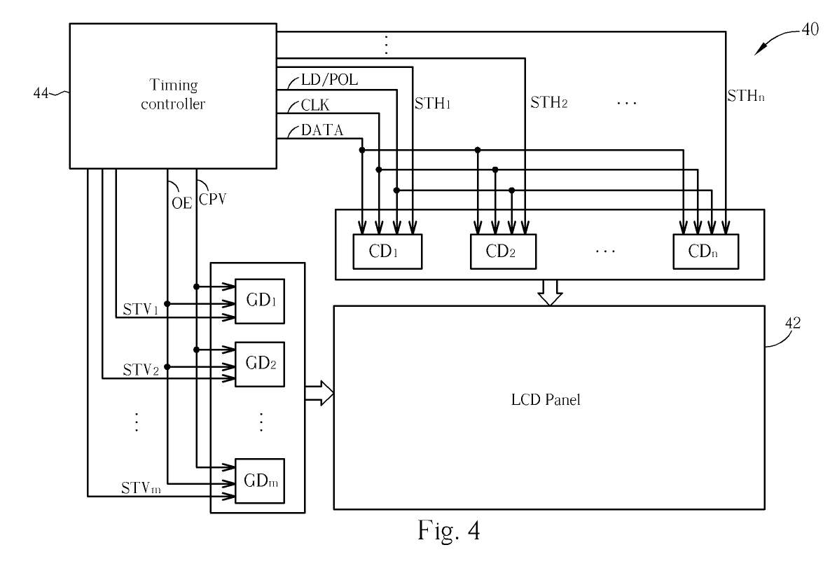

Reference is made to FIG. 4 for a diagram illustrating an L-configuration LCD device 40 according to a first embodiment of the present invention. The LCD device 40 includes an LCD panel 42, a timing controller 44, a plurality of gate drivers GD₁-GDₘ, and a plurality of source drivers CD₁-CDₙ. A plurality of pixel units, each including devices such as liquid crystal capacitors, storage capacitors and TFT switches, are disposed on the LCD panel 42. The timing controller 44 can generate a data signal DATA corresponding to images to be displayed on the LCD panel 42, horizontal synchronization signals STH₁-STHₙ for accessing valid data, a horizontal clock signal CLK and horizontal control signals for operating the source drivers CD₁-CDₙ, as well as vertical synchronization signals STV₁-STVₘ, a vertical clock signal CPV and vertical control signals for operating the gate drivers GD₁-GDₘ. In FIG. 4, the horizontal control signals include a latch control signal LD and a polarity control signal POL, while the vertical control signals include an output enable signal OE. In the first embodiment of the present invention, the timing controller 44 generates the horizontal synchronization signals STH₁-STHₙ respectively corresponding to the source drivers CD₁-CDₙ and the vertical synchronization signal STV₁-STVₘ respectively corresponding to the gate drivers GD₁-GDₘ. Therefore, the timing controller 44 can output source driving signals to the sources drivers CD₁-CDₙ based on the data signal DATA, the corresponding horizontal synchronization signals, the horizontal clock signal CLK, the latch control signal LD, and the polarity control signal POL. Meanwhile, the timing controller 44 can also output gate driving signals to the gate drivers GD₁-GDₘ based on the corresponding vertical synchronization signals, the vertical clock signal CPV, and the output enable signal OE.

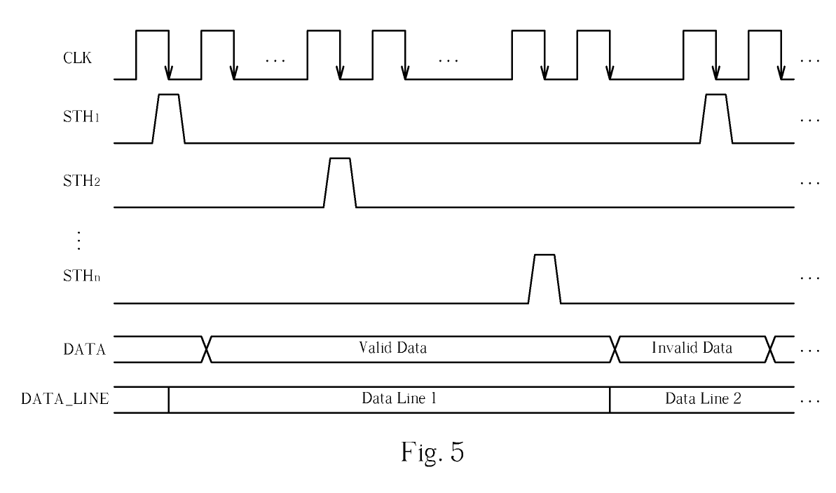

Reference is made to FIG. 5 for a timing diagram illustrating the operations of the source drivers in the LCD device 40 according to the first embodiment of the present invention. In FIG. 5, STH₁-STHₙ represent the ideal waveform of the synchronization signals respectively received by the source drivers CD₁-CDₙ. Waveform DATA represents the ranges of valid and invalid data. DATA_LINE represents the accessed data lines. Based on the signal transmission paths between the timing controller 44 and the source drivers CD₁-CDₙ, the timing controller 44 outputs corresponding horizontal synchronization signals STH₁-STHₙ. Since the horizontal synchronization signals STH₁-STHₙ are each individually controlled by the timing controller 44 and thus independent on each other, the horizontal synchronization signals STH₁-STHₙ encounter similar signal path delays. In high-speed and high-resolution applications, the LCD device 40 can also individually adjust the timing characteristics of the data signal, the clock signal, the control signals and the synchronization signals for each drivers.

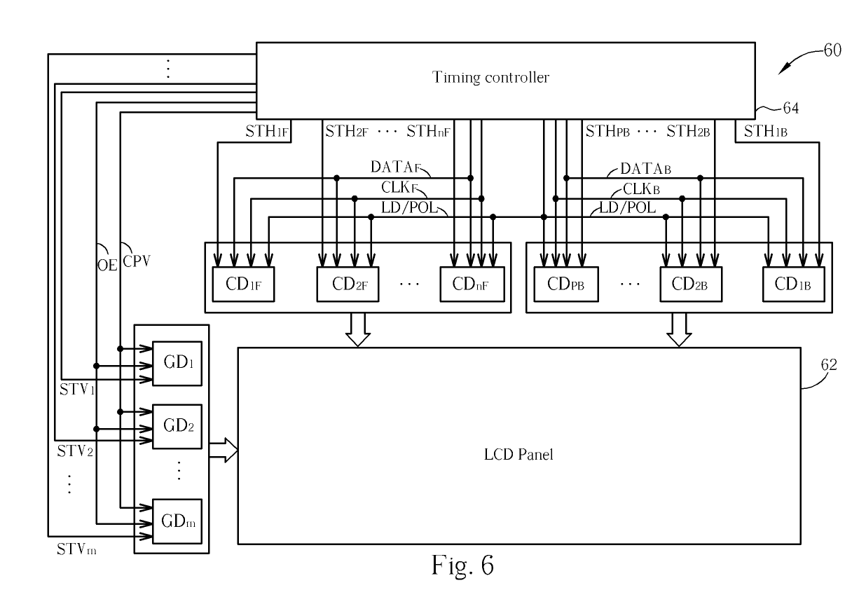

Reference is made to FIG. 6 for a diagram illustrating a T-configuration LCD device 60 according to a second embodiment of the present invention. The LCD device 60 includes an LCD panel 62, a timing controller 64, a plurality of gate drivers GD₁-GDₘ, and a plurality of source drivers. The source drivers of the LCD device 60 include n front-port source drivers CD_{1F}-CD_{nF} and p back-port source drivers CD_{1B}-CD_{pB}, wherein the timing controller 64 is disposed between the front-port source drivers CD_{1F}-CD_{nF} and the back-port source drivers CD_{1B}-CD_{pB}. The timing controller 64 can generate data signals DATA_{F} and DATA_{B} corresponding to images to be displayed on the LCD panel 62, horizontal synchronization signals STH_{1F}-STH_{nF} and STH_{1B}-STH_{pB} for accessing valid data, horizontal clock signals CLK_{F}, CLK_{B} and horizontal control signals for operating the source drivers, as well as vertical synchronization signals STV₁-STVₘ, a vertical clock signal CPV and vertical control signals for operating the gate drivers GD₁-GDₘ. In FIG. 6, the horizontal control signals include a latch control signal LD and a polarity control signal POL, while the vertical control signals include an output enable signal OE. In the second embodiment of the present invention, the timing controller 64 generates the horizontal synchronization signals STH_{1F}-STH_{nF} respectively corresponding to the front-port source drivers CD_{1F}-CD_{nF}, the horizontal synchronization signals STH_{1B}-STH_{pB} respectively corresponding to the back-port source drivers CD_{1B}-CD_{pB}, and the vertical synchronization signal STV₁-STVₘ respectively corresponding to the gate drivers GD₁-GDₘ. Therefore, the timing controller 64 can output source driving signals to the front-port sources drivers CD_{1F}-CD_{nF} based on the data signal DATA_{F}, the corresponding horizontal synchronization signals, the horizontal clock signal CLK_{F}, the latch control signal LD, and the polarity control signal POL, and can output source driving signals to the back-port sources drivers CD_{1B}-CD_{pB} based on the data signal DATA_{B}, the corresponding horizontal synchronization signals, the horizontal clock signal CLK_{B}, the latch control signal LD, and the polarity control signal POL. Meanwhile, the timing controller 64 can also output gate driving signals to the gate drivers GD₁-GDₘ based on the corresponding vertical synchronization signals, the vertical clock signal CPV, and the output enable signal OE.

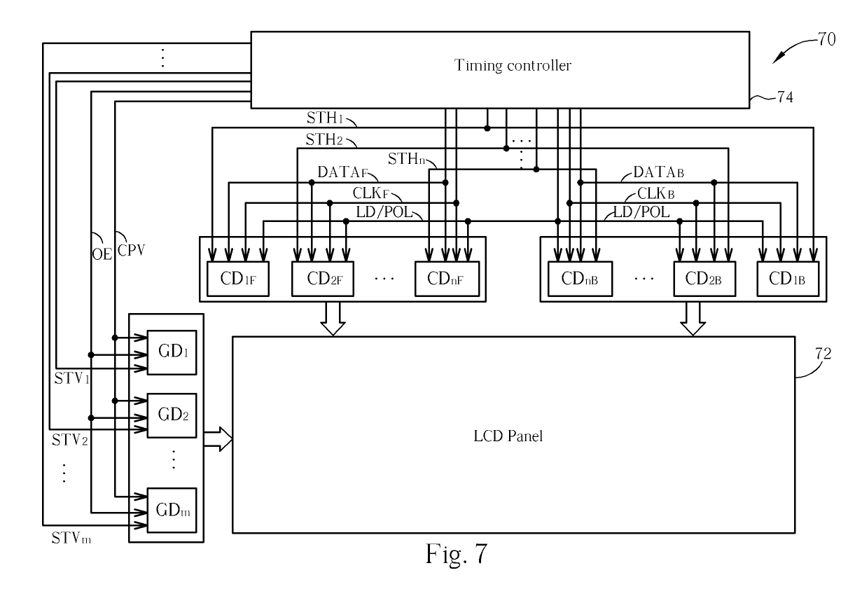

Reference is made to FIG. 7 for a diagram illustrating a T-configuration LCD device 70 according to a third embodiment of the present invention. The LCD device 70 includes an LCD panel 72, a timing controller 74, a plurality of gate drivers GD₁-GDₘ, and a plurality of source drivers. The source drivers of the LCD device 70 include n front-port source drivers CD_{1F}-CD_{nF} and n back-port source drivers CD_{1B}-CD_{nB}, wherein the timing controller 74 is disposed between the front-port source drivers CD_{1F}-CD_{nF} and the back-port source drivers CD_{1B}-CD_{nB}. The timing controller 74 can generate data signals DATA_{F} and DATA_{B} corresponding to images to be displayed on the LCD panel 72, horizontal synchronization signals STH₁-STHₙ for accessing valid data, horizontal clock signals CLK_{F}, CLK_{B} and horizontal control signals for operating the source drivers, as well as vertical synchronization signals STV₁-STVₘ, a vertical clock signal CPV and vertical control signals for operating the gate drivers GD₁-GDₘ. In FIG. 7, the horizontal control signals include a latch control signal LD and a polarity control signal POL, while the vertical control signals include an output enable signal OE. In the third embodiment of the present invention, the timing controller 74 generates the horizontal synchronization signals STH₁-STHₙ respectively corresponding to the front/back-port source drivers and the vertical synchronization signal STV₁-STVₘ respectively corresponding to the gate drivers GD₁-GDₘ. Therefore, the timing controller 74 can output source driving signals to the front-port sources drivers CD_{1F}-CD_{nF} based on the data signal DATA_{F}, the corresponding horizontal synchronization signals, the horizontal clock signal CLK_{F}, the latch control signal LD, and the polarity control signal POL, and can output source driving signals to the back-port sources drivers CD_{1B}-CD_{nB} based on the data signal DATA_{B}, the corresponding horizontal synchronization signals, the horizontal clock signal CLK_{B}, the latch control signal LD, and the polarity control signal POL. Meanwhile, the timing controller 74 can also output gate driving signals to the gate drivers GD₁-GDₘ based on the corresponding vertical synchronization signals, the vertical clock signal CPV, and the output enable signal OE.

Reference can also be made to FIG. 5 for a timing diagram illustrating the operations of the source drivers in the LCD device 70 according to the third embodiment of the present invention. Based on the signal transmission paths between the timing controller 74 and the source drivers, the timing controller 74 outputs corresponding horizontal synchronization signals STH₁-STHₙ. Since the horizontal synchronization signals STH₁-STHₙ are each individually controlled by the timing controller 74 and thus independent on each other, the horizontal synchronization signals STH₁-STHₙ encounter similar signal path delays. In high-speed and high-resolution applications, the LCD device 70 can also individually adjust the timing characteristics of the data signal, the clock signal, the control signals and the synchronization signals for each drivers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD) device capable of reducing skew and variations in signal path delay comprising:
an LCD panel including a plurality of display units;
a plurality of source drivers each capable of outputting a source driving signal to corresponding display units of the LCD display panel based on a horizontal clock signal, a data signal, a horizontal control signal, and a corresponding horizontal synchronization signal; and
a timing controller for generating the horizontal clock signal, the data signal and the horizontal control signal, and for outputting a plurality of horizontal synchronization signals respectively corresponding to the plurality of source drivers based on signal transmission paths between the plurality of source drivers and the timing controller.

2. The LCD device of claim 1 further comprising:
a plurality of gate drivers each capable of outputting a gate driving signal to corresponding display units of the LCD display panel based on a vertical clock signal, a vertical control signal, and a corresponding vertical synchronization signal.

3. The LCD device of claim 2 wherein the timing controller further outputs the vertical clock signal and the vertical control signal, and further outputs corresponding a plurality of vertical synchronization signals respectively corresponding to the plurality of gate drivers based on signal transmission paths between the plurality of gate drivers and the timing controller.

4. The LCD device of claim 2 further comprising:
a plurality of signal lines for transmitting the vertical clock signal, the vertical control signal, and the vertical synchronization signals corresponding to the plurality of gate drivers.

5. The LCD device of claim 1 further comprising:
a plurality of signal lines for transmitting the horizontal clock signal, the data signal, the horizontal control signal, and the horizontal synchronization signals corresponding to the plurality of source drivers.

6. A method capable of reducing skew and variations in signal path delay in a display device comprising:
a timing controller outputting a plurality of horizontal synchronization signals respectively corresponding to a plurality of source drivers based on signal transmission paths between the plurality of source drivers and the timing controller; and
a source driver among the plurality of source drivers outputting a source driving signal based on a horizontal clock signal, a data signal, a horizontal control signal, and a corresponding horizontal synchronization signal among the plurality of horizontal synchronization signals.

7. The method of claim 6 further comprising:
the timing controller generating the horizontal clock signal, the data signal, and the horizontal control signal.

8. The method of claim 6 wherein the source driver outputs the source driving signal to corresponding display units of a display panel.

9. The method of claim 6 further comprising:
the timing controller outputting a plurality of vertical synchronization signals respectively corresponding to a plurality of gate drivers based on signal transmission paths between the plurality of gate drivers and the timing controller; and
a gate driver among the plurality of gate drivers outputting a gate driving signal based on a vertical clock signal, a vertical control signal, and a corresponding vertical synchronization signal among the plurality of vertical synchronization signals.

10. The method of claim 9 further comprising:
the timing controller generating the vertical clock signal and the vertical control signal.

11. The method of claim 9 wherein the gate driver outputs the gate driving signal to corresponding display units of a display panel.
